(19) United States
(12) Patent Application Publication
(10) Pub. No.: US 2025/0287248 A1
(43) Pub. Date: Sep. 11, 2025

(54) NEIGHBOR REPORT ENHANCEMENT FOR ROAMING

(71) Applicant: Cisco Technology, Inc., San Jose, CA (US)

(72) Inventors: Binita Gupta, San Diego, CA (US); Brian D. Hart, Sunnyvale, CA (US)

(73) Assignee: Cisco Technology, Inc., San Jose, CA (US)

(21) Appl. No.: 19/075,439

(22) Filed: Mar. 10, 2025

Related U.S. Application Data
(60) Provisional application No. 63/563,271, filed on Mar. 8, 2024.

(51) Int. Cl. H04W 24/10; H04L 61/5084

(52) U.S. Cl. CPC H04W 24/10; H04L 61/5084

(57) ABSTRACT

Neighbor Report (NR) enhancement for roaming may be provided. A neighbor Access Point (AP) of a reporting AP may be determined. Whether the neighbor AP belongs to a same Seamless Mobility Domain (SMD) as the reporting AP may be determined. The SMD may include a plurality of AP Multi-Link Devices (MLDs). Each of the plurality of AP MLD may include one or more APs. Same SMD information may be include in an NR element. The same SMD information may include whether the neighbor AP MLD belongs to the same SMD as the reporting AP MLD. The NR element may be provided to a station.

### RELATED APPLICATION

Under provisions of 35 U.S.C. § 119(e), Applicant claims the benefit of U.S. Provisional Application No. 63/563,271, filed Mar. 8, 2024, which is incorporated herein by reference.

### TECHNICAL FIELD

The present disclosure relates generally to neighbor report enhancement for seamless roaming.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various implementations of the present disclosure. In the drawings:

FIG. 1 is a block diagram of an operating environment for providing neighbor report enhancement for roaming;

FIG. 2 is a flow chart of a method for providing Reduced Neighbor Report (RNR) enhancement for roaming;

FIG. 3A shows a Basic Service Set (BSS) parameters subfield format in an RNR element;

FIG. 3B shows a Multi-Link Device (MLD) parameters subfield format 320 an RNR element;

FIG. 3C shows a Target Beacon Transmission Time (TBTT) information field format in an RNR element;

FIG. 3D shows an SMD parameters subfield format in an RNR element;

FIG. 4A is a flow chart of a method for providing Neighbor Report (NR) enhancement for roaming;

FIG. 4B shows a NR element format;

FIG. 5 is a flow chart of a method for providing neighbor report enhancement for roaming; and

FIG. 6 is a block diagram of a computing device.

### DETAILED DESCRIPTION

### Overview

Neighbor Report (NR) enhancement for roaming may be provided. A neighbor Access Point (AP) of a reporting AP may be determined. Whether the neighbor AP belongs to a same Seamless Mobility Domain (SMD) as the reporting AP may be determined. The SMD may include a plurality of AP Multi-Link Devices (MLDs). Each of the plurality of AP MLDs may include one or more APs. Same SMD information may be included in a Neighbor Report (NR) element. The same SMD information may include whether the neighbor AP belongs to the same SMD as the reporting AP. The NR element may be provided to a station. In some examples, the same SMD information may be include in a Reduced Neighbor Report (RNR) element and the RNR element may be provided to the station.

In an example, whether the neighbor AP belongs to a same Fast-Basic Service Set (BSS) Transition (FT) Mobility Domain (FT MD) as the reporting AP may be determined. The FT MD may include a plurality of AP MLDs. Same FT MD information may be included in an RNR element or a NR element. The same FT MD information may indicate whether the neighbor AP belongs to the same FT MD as the reporting AP. An FT MD identifier may be included in the RNR element or the NR element when the neighbor AP does not belong to the same FT MD as the reporting AP.

Both the foregoing overview and the following example implementations are examples and explanatory only and should not be considered to restrict the disclosure's scope, as described and claimed. Furthermore, features and/or variations may be provided in addition to those described. For example, implementations of the disclosure may be directed to various feature combinations and sub-combinations described in the example implementations.

### EXAMPLE IMPLEMENTATIONS

The following detailed description refers to the accompanying drawings. Wherever possible, the same reference numbers are used in the drawings and the following description to refer to the same or similar elements. While implementations of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Seamless roaming capability has been an area of interest for improving roaming quality within wireless networks. For instance, the next generation of the Institute of Electrical and Electronics Engineers (IEEE) 802.11 (that is, Wi-Fi 8) may seek roaming enhancements to support more reliable and seamless roaming. To achieve seamless roaming, a roaming transition time and delays added due to roaming related operations may need to be reduced. In one example, to support seamless roaming, a Station (STA) may create an association with a Seamless Mobility Domain (SMD) instead of with an individual Access Point (AP). Associating with a SMD may enable the STA to roam seamlessly between member APs of the SMD without requiring reassociation and reestablishment of contexts with each new AP. That is, associating with a SMD may ensure that when the STA moves from the current AP to a target AP, the STA may not need to perform reassociation and rekeying, and the STA context may be transferred from the current AP to the target AP to achieve seamless roaming. Thus, by enabling the STA to associate with a SMD that includes multiple member APs may significantly reduce roaming time to realize seamless roaming (e.g., smooth and continuous roaming with no apparent interruption in data communication) and significantly improve a STA's wireless performance in terms of increased throughput, reduced latency, and higher range, as illustrative, non-limiting examples.

In one embodiment, the SMD information may be provided in a Neighbor Report (NR) or a Reduced Neighbor Report (RNR) by a reporting AP. When a STA receives a RNR, for example, in a beacon or a probe response, the STA may learn information about a neighbor AP of the reporting AP. The STA may be benefitted by learning which of the reported AP in the RNR belong to the same SMD as the reporting AP from which the STA is getting the RNR. When roaming, this same SMD information may enable the STA to select a neighbor AP which is part of the same SMD as the reporting AP to achieve seamless roaming. For example, by selecting select the neighbor AP which is part of the same SMD, the STA may significantly reduce roaming time to realize seamless roaming (e.g., smooth and continuous roaming with no apparent interruption in data communication) and significantly improve a STA's wireless performance in terms of increased throughput, reduced latency, and higher range, as illustrative, non-limiting examples. This disclosure provides enhancements to the NR and the RNR for signaling SMD information of neighbor APs.

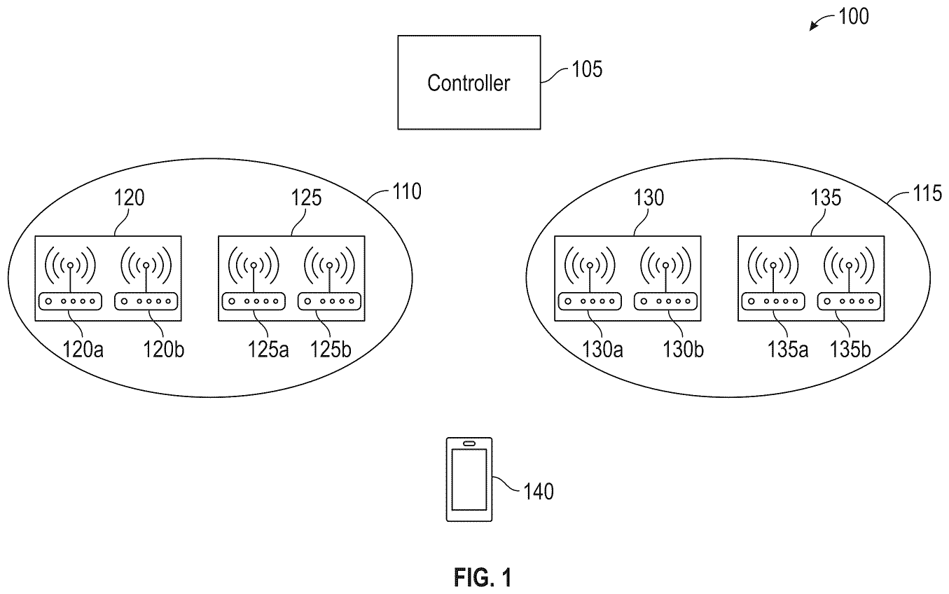

FIG. 1 is a block diagram of an operating environment 100 for providing NR enhancement for roaming. As shown in FIG. 1, operating environment 100 may comprise a controller 105 a plurality of SMDs, for example, a first SMD 110 and a second SMD 115. Each of the plurality of SMDs may include a plurality of AP Multi-Link Devices (MLDs). For example, and as shown in FIG. 1, first SMD 110 may include a first AP MLD 120 and a second AP MLD 125. Second SMD 115 may include a third AP MLD 130 and a fourth AP MLD 135. Each of the plurality of AP MLDs may include one or more APs. For example, a first AP MLD 120 may include a first AP 120aand a second AP 120b, second AP MLD 125 may include a third AP 125a and a fourth AP 125b, a third AP MLD 130 may include a fifth AP 130a and a seventh AP 130b, and fourth AP MLD 125 may include an eight AP 135a and a ninth AP 135b. In some examples, APs of an AP MLD may be part of two different SMDs. Although operating environment 100 is shown to include two SMDs and each of two SMDs include two AP MLDs, operating environment may include a different number of SMDs and each of the SMDs may include a different number of AP MLDs. In some example, operating environment 100 may include Fast Basic Service Set (BSS) Transition (FT) Mobility Domain (MD) as defined in IEEE 802.11r, where each MD may include one or more SMDs. Each FT MD may be identified by an FT MD identifier (FT MD ID).

Each of the plurality of SMDs may provide a coverage environment, for example, but is not limited to, a Wireless Local Area Network (WLAN) comprising a plurality of AP MLDs that may provide wireless network access (e.g., access to the WLAN for a STA 140 as it moves within the coverage environment). STA 140 may comprise, but are not limited to, a smart phone, a Head Mounted Device (HMD), a mice, a keyboard, a personal computer, a tablet device, a mobile device, a telephone, a remote control device, a set-top box, a digital video recorder, an Internet-of-Things (IoT) device, a network computer, a router, Augmented Reality (AR)/Virtual Reality (VR)/XR devices, or other similar microcomputer-based device. Each of the plurality of APs may be compatible with specification standards such as, but not limited to, the IEEE 802.11 specification standard for example.

The plurality of APs and STA 140 of operating environment 100 may use Multi-Link Operation (MLO) where they simultaneously transmit and receive across different bands and channels by establishing two or more links to two or more AP radios. These bands may comprise, but are not limited the 2 GHz band, the 5 GHZ band, the 6 GHz band, and the 60 GHz band.

Controller 105 may comprise a Wireless Local Area Network (LAN) Controller (WLC) and may provision and control the coverage environment (for example, a WLAN). In some implementations of the disclosure, controller 105 may be implemented by a Digital Network Architecture Center (DNAC) controller (i.e., a Software-Defined Network (SDN) controller.

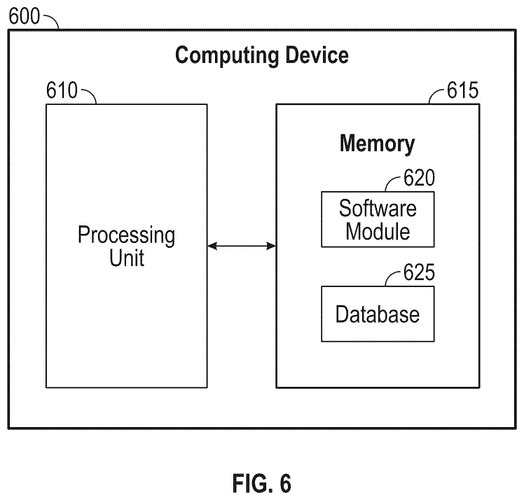

The elements described above of operating environment 100 (e.g., controller 105, first AP MLD 120, second AP MLD 125, third AP MLD 130, fourth AP MLD 135, or STA 140) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 6, the elements of operating environment 100 may be practiced in a computing device 600.

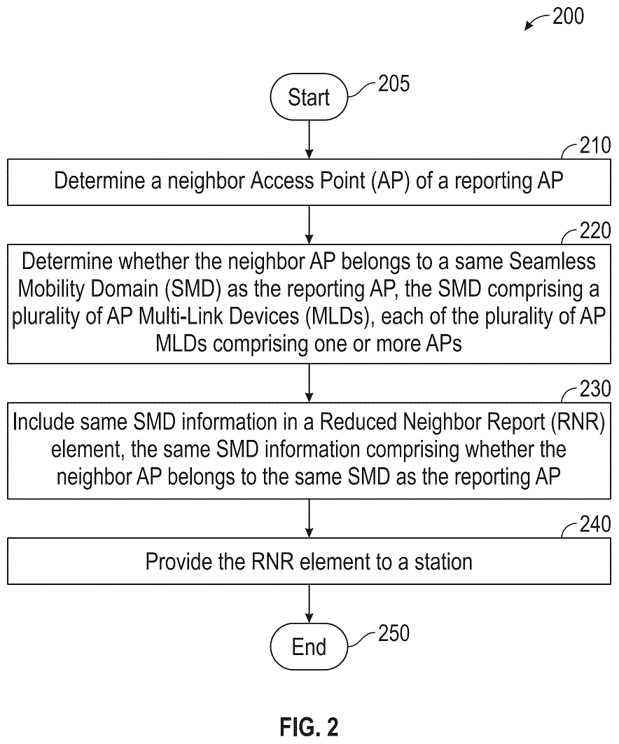

FIG. 2 is a flow chart setting forth the general stages involved in a method 200 consistent with implementations of the disclosure for providing RNR enhancement for roaming. Method 200 may be implemented using controller 105 as described in more detail above with respect to FIG. 1. In some examples, method 200 may be implemented using any of the plurality of APs of any of the plurality of SMDs as described in more detail above with respect to FIG. 1. Ways to implement the stages of method 200 will be described in greater detail below.

Method 200 may begin at starting block 205 and proceed to stage 210 where controller 105 may determine a neighbor AP of a reporting AP. The neighbor AP may be in a range of the reporting AP. In one example, the reporting AP may be fourth AP 125b and the neighbor AP may be one or more of second AP 120b, fifth AP 130a, sixth AP 130b, etc. Controller 105 may determine the neighbor AP of the reporting AP based on a physical location, a logical arrangement, or an assignment of APs in operating environment 100. In some examples, the neighbor AP of the reporting AP may be determined by the reporting AP based on eavesdropping on inter AP signaling.

After determining the neighbor AP of the reporting AP at stage 210, method 200 may proceed to stage 220 where controller 105 may determine whether the neighbor AP belongs to a same SMD as the reporting AP. As discussed above the SMD may include a plurality of AP MLDs, each of the plurality of AP MLDs including one or more APs. Controller 105 may determine whether the neighbor AP belongs to a same SMD as the reporting AP based on SMD membership information associated with each of the neighbor AP and the reporting AP. For example, controller 105 may determine that second AP 120 belongs to a same SMD (that is, first SMD 110) as fourth AP 125b while fifth AP 130a does not belong to the same SMD as fourth AP 125b. In some examples, the neighbor AP and the reporting AP may belong to different AP MLDs that are part of the same SMD or different SMDs.

Once having determined whether the neighbor AP belongs to the same SMD as the reporting AP at stage 220, method 200 may proceed to stage 230 where controller 105 may include same SMD information in an RNR element. The same SMD information may include an indication of whether the neighbor AP belongs to the same SMD as the reporting AP.

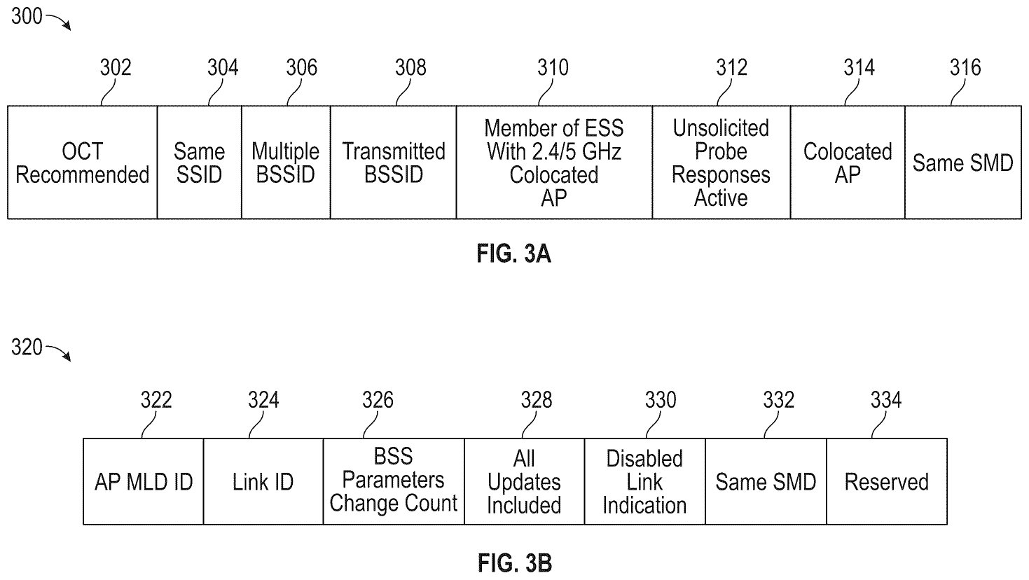

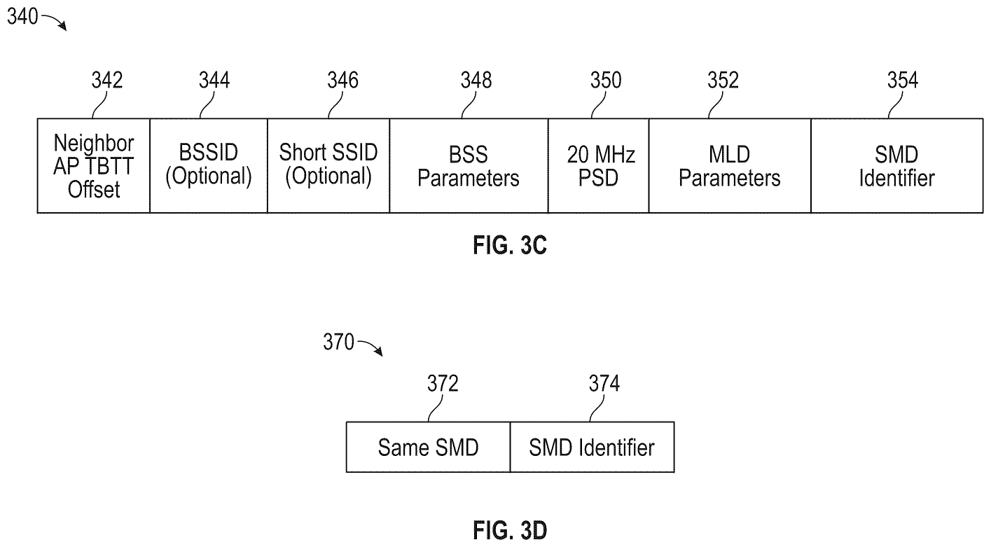

In one example, whether the neighbor AP (also referred to as a reported AP) is part of the same SMD as the reporting AP may be indicated by using a reserved bit field in a Basic Service Set (BSS) parameters subfield in the RNR element. For example, a reserved bit field in the BSS parameters subfield in the RNR element may be re-purposed as a same SMD indication field. FIG. 3A shows a BSS parameters subfield format 300 in the RNR element. As shown in FIG. 3A, BSS parameters subfield format 300 includes an OCT recommended subfield 302, a same Service Set Identifier (SSID) subfield 304, a multiple BSS Identifier (BSSID) subfield 306, a transmitted BSSID subfield 308, a member of Extended Service Set (ESS) subfield 310, an unsolicited probe responses active subfield 312, a collocated AP subfield 314, and a same SMD subfield 316. A length or a size of each of OCT recommended subfield 302, same SSID subfield 304, a multiple BSSID subfield 306, transmitted BSSID subfield 308, a member of ESS subfield 310, unsolicited probe responses active subfield 312, collocated AP subfield 314, and same SMD subfield 316 is 1 bit.

As shown in FIG. 3A, the reserved sub-field of BSS parameters subfield format 300 is re-purposed as same SMD subfield 316 indicating whether the reported AP is part of the same SMD as the reporting AP. A bit in same SMD subfield 316 may be set to a first value (for example, 1) if the SMD of the reported AP is same as the SMD of the reporting AP. If the reporting and reported APs are part of different SMDs, then the bit in same SMD subfield 316 may be set to a second value (for example, 0).

In another example embodiment, one of reserved bits subfield in a MLD parameters subfield may be used to signal the same SMD information. FIG. 3B shows a MLD parameters subfield format 320 in an RNR element. As shown in FIG. 3B, MLD parameters subfield format 320 may include an AP MLD ID subfield 322, a link ID subfield 324, a BSS parameters change count subfield 326, an all updates included subfield 328, a disabled link indication subfield 330, a same SMD field 332, and a reserved field 334. A length of each of AP MLD ID subfield 322 and BSS parameters change count subfield 326 may be of 8 bits. A length of link ID subfield 324 may be of 4 bits. A length of each of all updates included subfield 328, disabled link indication subfield 330, same SMD field 332, and reserved field 334 may be 1 bit.

Same SMD field 332 of MLD parameters subfield format 320 may contain a single bit. The single bit of same SMD field 332 may be set to a first value (for example, 1) if the SMD of the reported AP is same as the SMD of the reporting AP. If the reporting AP and the reported AP are part of different SMDs, then this bit may be set to a second value (for example, 0). If same SMD field 332 is set to the second value indicating different SMDs for the reporting AP and the reported AP, then a SMD parameters field may be included in a Target Beacon Transmission Time (TBTT) information field in the RNR IE. A new TBTT information field may be defined to signal SMD parameters that provides a SMD ID.

FIG. 3C shows a TBTT information field format 340 in an RNR element. As shown in FIG. 3C, TBTT information field format 340 may include a neighbor AP TBTT offset field 342, a BSSID (optional) field 344, a short SSID (optional) field 346, a BSS parameters field 348, a 20 MHz Power Spectral Density (PSD) field 350, a MLD parameters field 352, and a SMD identifier field 354. Neighbor AP TBTT offset field 342 may be of 1 octet, BSSID (optional) field 344 may be of 0 or 6 octets, short SSID (optional) field 346 may be of 0 or 4 octets, BSS parameters field 348 may be of 0 or 1 octet, 20 MHz PSD field 350 may be of 0 or 1 octet, and MLD parameters field 352 may be of 0 or 3 octets. SMD identifier field 354 may be of a variable length, for example, 0, 1, 2, 3, 4, or 6 octets.

In one embodiment, SMD identifier field 354 may indicate a short SMD identifier identifying the SMD of the reported AP MLD. The short SMD identifier may be of 1, 2, 3 or 4 bytes. In another embodiment, SMD identifier field 354 may indicate a SMD MAC address as a SMD identifier and may be of 6 bytes. In one embodiment, SMD identifier field 354 may be included if same SMD field 316 or 332 is set to the second value. In another embodiment, SMD identifier field 354 may be included independent of whether same SMD 332 subfield is set to the first value or the second value. In one embodiment, SMD identifier field 354 may be included in the MLD parameters subfield in the TBTT information field.

In another embodiment, the same SMD indication may also be provided in an SMD parameters subfield in a TBTT information field, instead of in the BSS parameters or the MLD parameters as shown in FIG. 3D. FIG. 3D shows an SMD parameters subfield format 370 that can be included in an RNR element. As shown in FIG. 3D, in this embodiment, SMD parameters subfield 370 may include both a same SMD subfield 372 and an SMD ID subfield 374. Same SMD subfield 372 may be 1 bit long and. SMD ID subfield 376 may be of variable length and may depend on a type of SMD ID. For example, SMD ID subfield 376 may be 4-7 bits long or 1, 2, 4 or 6 octets long.

The bit in same SMD subfield 372 may be set to a first value (for example, 1) if the reported AP and the reporting AP belong to the same SMD. If the reporting and reported APs are part of different SMDs, then the bit in same SMD subfield 372 may be set to a second value (for example, 0). If the same SMD subfield 372 bit is set to the second value, then SMD identifier field 376 may be included to indicate the SMD ID for the other SMD of the reported AP. In one embodiment, SMD identifier field 376 is included independent of whether same SMD subfield 372 is set to first value or the second value.

Once having included the same SMD information in the RNR element at stage 230, method 200 proceed to stage 240 where the RNR element is provided to STA 140. For example, the reporting AP may provide the enhanced RNR (that is, the RNR containing the same SMD information, also referred to as an enhanced RNR) to STA 140. The RNR enhancements for roaming described above may be applicable and included in all the frames where RNR element is carried, including a beacon, a probe response, a Fast Initial Link Setup (FILS) discovery message, etc. After providing the RNR element to STA 140 at stage 240, method 200 may terminate at end block 250.

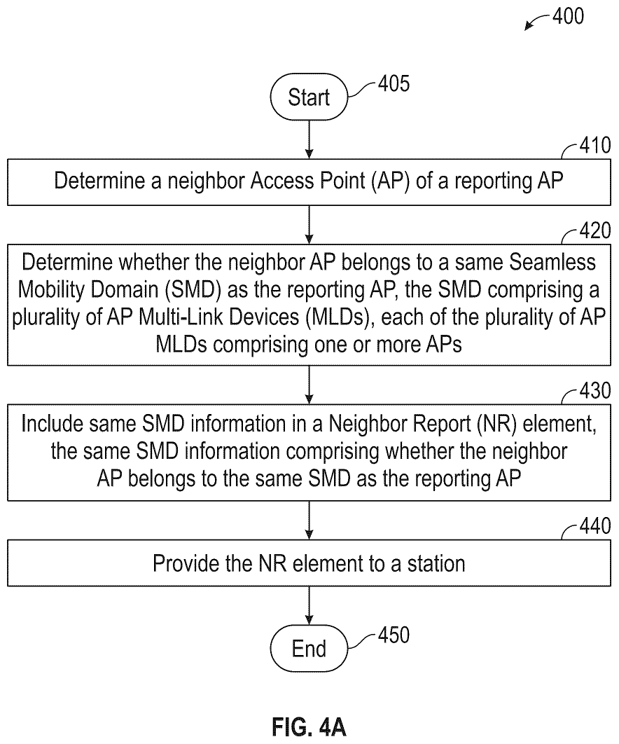

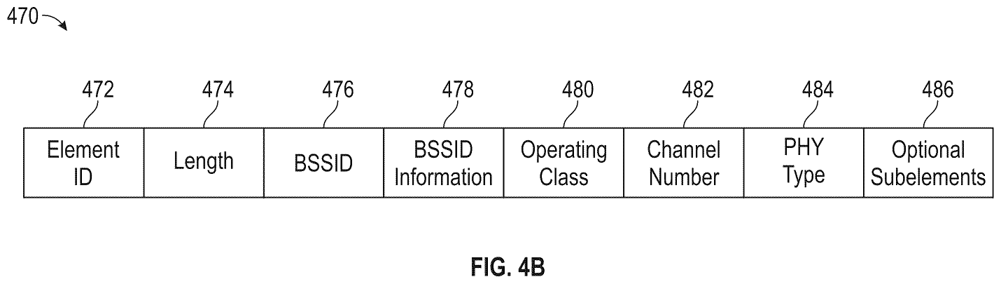

FIG. 4A is a flow chart setting forth the general stages involved in a method 400 consistent with implementations of the disclosure for providing NR enhancement for roaming. Method 400 may be implemented using controller 105 as described in more detail above with respect to FIG. 1. In some examples, method 400 may be implemented using any of the plurality of APs of any of the plurality of SMDs as described in more detail above with respect to FIG. 1. Ways to implement the stages of method 400 will be described in greater detail below.

Method 400 may begin at starting block 405 and proceed to stage 410 where controller 105 may determine a neighbor AP of a reporting AP. As discussed above, controller 105 may determine the neighbor AP of the reporting AP based on a physical location, a logical arrangement, or an assignment of APs in operating environment 100. In some examples, the neighbor AP of the reporting AP may be determined by the reporting AP based on eavesdropping on inter AP signaling.

After determining the neighbor AP of the reporting AP at stage 410, method 400 may proceed to stage 420 where controller 105 may determine whether the neighbor AP belongs to a same SMD as the reporting AP. As discussed above, controller 105 may determine whether the neighbor AP belongs to a same SMD as the reporting AP based on SMD members information of each of the reporting and neighbor APs.

Once having determined whether the neighbor AP belongs to the same SMD as the reporting AP at stage 420, method 400 may proceed to stage 430 where controller 105 may include same SMD information in an NR element. The same SMD information may include an indication of whether the neighbor AP belongs to the same SMD as the reporting AP.

In example embodiments, the NR element may include a SMD element as a sub-element indicating the SMD of the reported AP. The NR in a BSS Transition Management (BTM) request may also carry the SMD element. The SMD element may signal the SMD identifier (for example, an SMD Media Access Control (MAC) Address), or alternatively a short SMD ID (for example, 1, 2, 3, or 4 octets), etc.). The SMD element of the NR may also include SMD capabilities, SMD related policy, and other SMD parameters.

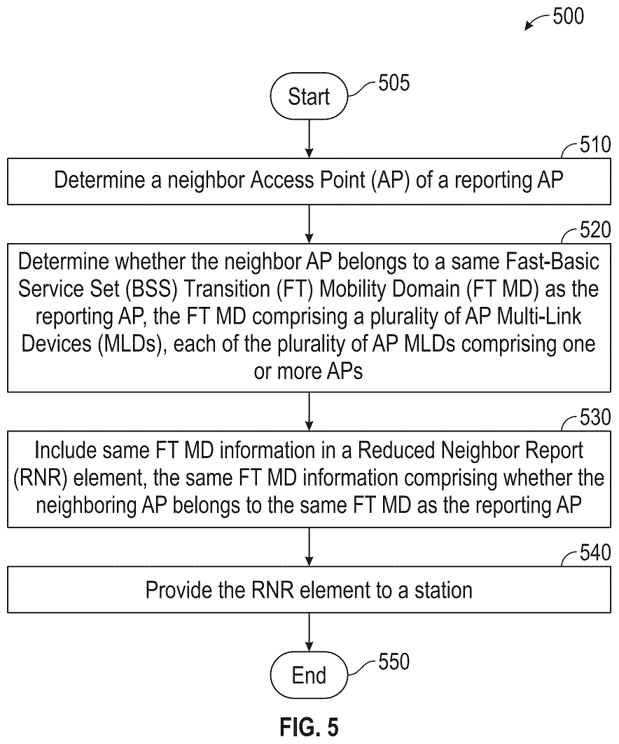

FIG. 4B shows an NR element format 470. As shown in FIG. 5, NR element format 400 may include an element ID field 472, a length field 474, a BSSID field 476, a BSSID information field 478, an operating class field 480, a channel number field 482, a PHY type field 484, and an optional sub-elements field 486. Element ID field 472, length field 474, operating class field 480, channel number field 482, and PHY type field 484 may be 1 octet long. BSSID field 476 may be 6 octet long and BSSID information field 478 may be 4 octet long. Optional sub-elements field 486 may be of a variable length. In example, BSSID information field 478 may provide the same SMD indication and the SMD element may be include in optional sub-elements field 486.

The same SMD information may be provided by re-purposing a reserved bit in BSSID information field 478 in the NR element as a same SMD subfield. A bit value in the same SMD subfield is set to a first value when the neighbor AP belongs to the same SMD as the reporting AP. The bit value in the same SMD subfield may be set to a second value when the neighbor AP does not belong to the same SMD as the reporting AP. An SMD identifier of an SMD associated with the neighbor AP may also be provided in the NR element. In one example, the SMD identifier may be provided in the BSSID Information field 478 in the NR element. In another example, an SMD element may be provided in an optional sub-elements field 486 in the NR element. The SMD element may include one or more of the SMD identifier, SMD capabilities, and other SMD parameters of the SMD associated with the neighbor AP. In some examples, the SMD element is included in the NR element if the neighbor AP does not belong to the same SMD as the reporting AP. In one example, the SMD element is always included in optional sub-elements field 486 for a reported neighbor AP that belongs to an SMD.

Referring back to FIG. 4A., once having included the same SMD information in the NR element at stage 430, method 400 proceed to stage 440 where the NR element is provided to STA 140. The NR element may be provided to the station in a BSS Transition Management (BTM) request, a NR response, an association response, pr a reassociation response. After providing the NR element to STA 140 at stage 440, method 400 may terminate at end block 450.

FIG. 5 is a flow chart setting forth the general stages involved in a method 400 consistent with implementations of the disclosure for providing RNR enhancement for roaming. Method 500 may be implemented using controller 105 as described in more detail above with respect to FIG. 1. In some examples, method 500 may be implemented using any of the plurality of APs as described in more detail above with respect to FIG. 1. Ways to implement the stages of method 500 will be described in greater detail below.

Method 500 may begin at starting block 505 and proceed to stage 510 where controller 105 may determine a neighbor AP of a reporting AP. As discussed above, controller 105 may determine the neighbor AP of the reporting AP based on a physical location, a logical arrangement, or an assignment of APs in operating environment 100. In some examples, the neighbor AP of the reporting AP may be determined by the reporting AP based on eavesdropping on inter AP signaling.

After determining the neighbor AP of the reporting AP at stage 510, method 500 may proceed to stage 520 where controller 105 may determine whether the neighbor AP belongs to a same FT MD as the reporting AP. Controller 105 may determine whether the neighbor AP belongs to the same FT MD as the reporting AP based on FT MD membership information of each of the reporting AP and the neighbor AP.

Once having determined whether the neighbor AP belongs to the same FT MD as the reporting AP at stage 520, method 500 may proceed to stage 530 where controller 105 may include same FT MD information in an RNR element. The same SMD information may include an indication of whether the neighbor AP belongs to the same FT MD as the reporting AP. In some examples, the same FT MD information may be included in an NR element. The same FT MD information may be included in the RNR element and the NR element in a similar manner as the same SMD information as described above.

Once having included the same FT MD information in the RNR element at stage 530, method 500 proceed to stage 540 where the RNR element is provided to STA 140. After providing the RNR element to STA 140 at stage 540, method 500 may terminate at end block 550.

When STA 140 receives the RNR element or the NR element, STA 140 may learn which of the reported APs in the RNR or NR element belong to the same SMD or FT MD as the reporting AP. When roaming, this same SMD or FT MD information may enable STA 140 to select a neighbor AP which is part of the same SMD or FT MD as the reporting AP to achieve a seamless roaming. For example, by selecting the neighbor AP that is part of the same SMD, STA 140 may significantly reduce roaming time to realize seamless roaming and significantly improve its wireless performance in terms of increased throughput, reduced latency, and higher range, as illustrative, non-limiting examples.

FIG. 6 shows computing device 600. As shown in FIG. 6, computing device 600 may include a processing unit 610 and a memory unit 615. Memory unit 615 may include a software module 620 and a database 625. While executing on processing unit 610, software module 620 may perform, for example, processes for providing NR enhancement for roaming as described above with respect to FIGS. 2-5. Computing device 600, for example, may provide an operating environment for controller 105, first AP MLD 120, second AP MLD 125, third AP MLD 130, fourth AP MLD 135, and STA 140. Controller 105, first AP MLD 120, second AP MLD 125, third AP MLD 130, fourth AP MLD 135, or STA 140 may operate in other environments and are not limited to computing device 600.

Computing device 600 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 600 may comprise any computer operating environment, such as hand-held devices, multiprocessor systems, microprocessor-based or programmable sender electronic devices, minicomputers, mainframe computers, and the like. Computing device 600 may also be practiced in distributed computing environments where tasks are performed by remote processing devices. The aforementioned systems and devices are examples, and computing device 600 may comprise other systems or devices.

Implementations of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, implementations of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain implementations of the disclosure have been described, other implementations may exist. Furthermore, although implementations of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, implementations of the disclosure may be practiced in an electrical circuit comprising discrete electronic elements, packaged or integrated electronic chips containing logic gates, a circuit utilizing a microprocessor, or on a single chip containing electronic elements or microprocessors. Implementations of the disclosure may also be practiced using other technologies capable of performing logical operations such as, for example, AND, OR, and NOT, including but not limited to, mechanical, optical, fluidic, and quantum technologies. In addition, implementations of the disclosure may be practiced within a general purpose computer or in any other circuits or systems.

Implementations of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to implementations of the disclosure, may be performed via application-specific logic integrated with other components of computing device 500 on the single integrated circuit (chip).

Implementations of the present disclosure, for example, are described above with reference to block diagrams and/or operational illustrations of methods, systems, and computer program products according to implementations of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for implementations of the disclosure.

What is claimed is:

1. A method comprising:
determining a neighbor Access Point (AP) of a reporting AP;
determining whether the neighbor AP belongs to a same Seamless Mobility Domain (SMD) as the reporting AP, the SMD comprising a plurality of AP Multi-Link Devices (MLDs), wherein each of the plurality of AP MLDs comprises one or more APs;
including same SMD information in a Reduced Neighbor Report (RNR) element, the same SMD information comprising whether the neighbor AP belongs to the same SMD as the reporting AP; and
providing the RNR element to a station.

2. The method of claim 1, wherein the station roams to the neighbor AP in response to receiving the SMD information indicating that the neighbor AP belongs to the same SMD as the reporting AP.

3. The method of claim 1, wherein providing the RNR element to the station comprises:
providing the RNR element to the station in a beacon, a probe response, a multi-link probe response, an association response, a re-association response, or another management frame.

4. The method of claim 1, wherein including the same SMD information comprises including at least one of a same SMD indication field or an SMD identifier field in the RNR element.

5. The method of claim 1, wherein including the same SMD information comprises including the same SMD information in a reserved bit in a Basic Service Set (BSS) parameters subfield or in a one of reserved bits in a MLD parameters subfield in the RNR element.

6. The method of claim 1, wherein including the same SMD information comprises re-purposing a reserved bit in a BSS parameters subfield or in an MLD parameters subfield as a same SMD subfield, and wherein a bit value in the same SMD subfield is set to a first value when the neighbor AP belongs to the same SMD as the reporting AP.

7. The method of claim 6, wherein the bit value in the same SMD subfield is set to a second value when the neighbor AP does not belong to the same SMD as the reporting AP.

8. The method of claim 1, further comprising:
including a SMD identifier field in a MLD parameters subfield of a Target Beacon Transmission Time (TBTT) information field in the RNR element, the SMD identifier field providing an SMD identifier of an SMD associated with the neighbor AP.

9. The method of claim 8, wherein the SMD identifier is included in the RNR element in response to determining that the neighbor AP does not belong to the same SMD as the reporting AP.

10. The method of claim 1, wherein the neighbor AP and the reporting AP belong to different AP MLDs that are part of the same SMD or different SMDs.

11. A system comprising:
a memory storage; and
a processing unit coupled to the memory storage, wherein the processing unit is operative to:
determine a neighbor Access Point (AP) of a reporting AP;
determine whether the neighbor AP belongs to a same Fast Basic Service Set (BSS) Transition (FT) Mobility Domain (FT MD) as the reporting AP, the FT MD comprising a plurality of AP Multi-Link Devices (MLDs), each of the plurality of AP MLDs comprising one or more APs;
include same FT MD information in a Reduced Neighbor Report (RNR) element, the same FT MD information comprising whether the neighbor AP belongs to the same FT MD as the reporting AP; and
provide the RNR element to a station.

12. A non-transitory computer-readable medium that stores a set of instructions which when executed perform a method executed by the set of instructions comprising:
determining a neighbor Access Point (AP) of a reporting AP;
determining whether the neighbor AP belongs to a same Seamless Mobility Domain (SMD) as the reporting AP, the SMD comprising a plurality of AP Multi-Link Devices (MLDs), each of the plurality of AP MLDs comprising one or more APs;
including same SMD information in a Neighbor Report (NR) element, the same SMD information comprising whether the neighbor AP belongs to the same SMD as the reporting AP; and
providing the NR element to a station.

13. The non-transitory computer readable medium of claim 12, wherein including the SMD information comprises including one or more of a same SMD indication field or an SMD identifier field or an SMD element in the NR element.

14. The non-transitory computer readable medium of claim 12, wherein the same SMD information is included in a Basic Service Set Identifier (BSSID) information subfield in the NR element.

15. The non-transitory computer readable medium of claim 14, wherein including the same SMD information comprises re-purposing a reserved bit in the BSSID information subfield in the NR element as a same SMD subfield, and wherein a bit value in the same SMD subfield is set to a first value when the neighbor AP belongs to the same SMD as the reporting AP.

16. The non-transitory computer readable medium of claim 15, wherein the bit value in the same SMD subfield is set to a second value when the neighbor AP does not belong to the same SMD as the reporting AP.

17. The non-transitory computer readable medium of claim 16, further comprising providing an SMD identifier of an SMD associated with the neighbor AP in a BSS information subfield the NR element.

18. The non-transitory computer readable medium of claim 17, wherein the SMD element is included in an optional sub-elements field in the NR element, wherein the SMD element comprises one or more of the SMD identifier, SMD capabilities, and other SMD parameters of the SMD associated with the neighbor AP.

19. The non-transitory computer readable medium of claim 18, wherein the SMD element is included in the NR element when the neighbor AP does not belong to the same SMD as the reporting AP.

20. The non-transitory computer readable medium of claim 12, wherein the NR element is provided to the station in a BSS Transition Management (BTM) request, a Neighbor Report response, an association response, a reassociation response, or a management frame.
